(19) United States
(12) Patent Application Publication
(10) Pub. No.: US 2023/0305430 A1
(43) Pub. Date: Sep. 28, 2023

(54) DEVELOPING DEVICE AND IMAGE FORMING APPARATUS

(71) Applicant: KYOCERA Document Solutions Inc., Osaka (JP)

(72) Inventors: Tomohiro TAMAKI, Osaka (JP); Takahisa NAKAUE, Osaka (JP); Masahito ISHINO, Osaka (JP); Sueaki OKAMOTO, Osaka (JP)

(73) Assignee: KYOCERA Document Solutions Inc., Osaka (JP)

(21) Appl. No.: 18/186,050

(22) Filed: Mar. 17, 2023

(30) Foreign Application Priority Data
Mar. 25, 2022 (JP) 2022-049901

(51) Int. Cl. G03G 15/08

(52) U.S. Cl. CPC G03G 15/0812; G03G 15/0818; G03G 2215/0634

(57) ABSTRACT

A developing device includes a development container, a toner carrier, and a regulation blade. The toner carrier supplies toner contained in the development container to an image carrier in a facing region between the toner carrier and the image carrier. The regulation blade contacts the toner carrier on an upstream side of the facing region in a rotation direction of the toner carrier, and regulates a thickness of a layer of the toner carried on the toner carrier. The regulation blade is formed of a metal material polished in a direction same as a toner moving direction in a contact region between the regulation blade and the toner carrier such that an arithmetic average roughness of a surface of the regulation blade is 0.3 μm or less.

### INCORPORATION BY REFERENCE

This application is based on and claims the benefit of priority from Japanese Patent Application No. 2022-049901 filed on Mar. 25, 2022, the contents of which are hereby incorporated by reference.

### BACKGROUND

The present disclosure relates to a developing device and an image forming apparatus.

In electrophotographic image forming apparatuses such as electrophotographic copiers and printers, there is widely used a device that causes toner to adhere to the outer circumferential surface of a photosensitive drum, which is an image carrier, to thereby form a toner image to be later transferred onto a sheet. For example, a development device employing a non-magnetic one-component developing method includes a regulation blade that contacts a developing roller, which is as a toner carrier, to regulate the thickness of the layer of developer carried on the developing roller.

Such a developing device suffers a problem that toner is fused by heat generated by friction between the regulation blade and the developing roller in rotation and the fused toner sticks to the regulation blade. Such toner stuck to the regulation blade obstructs movement of toner on the developing roller, and may cause a white stripe in an image formed on a recording sheet.

### SUMMARY

According to one aspect of the present disclosure, a developing device includes a development container, a toner carrier, and a regulation blade. The development container contains therein toner to be supplied to an image carrier. The toner carrier is rotatably supported in the development container, and supplies the toner contained in the development container to the image carrier in a facing region between the toner carrier and the image carrier. The regulation blade contacts the toner carrier on an upstream side of the facing region in a rotation direction of the toner carrier, and regulates a thickness of a layer of the toner carried on the toner carrier. Here, the regulation blade is formed of a metal material polished in a direction same as a toner moving direction in a contact region between the regulation blade and the toner carrier such that an arithmetic average roughness of a surface of the regulation blade is 0.3 μm or less.

### BRIEF DESCRIPTION OF THE DRAWINGS

FIG. 1 is a schematic sectional side view of an image forming apparatus according to an embodiment of the present disclosure.

FIG. 2 is a sectional side view of the vicinity of an image forming portion of the image forming apparatus shown in FIG. 1.

FIG. 3 is a partial enlarged side view of the vicinity of a regulation blade of a developing device of the image forming portion shown in FIG. 2.

FIG. 4 is a schematic explanatory view of a contact region of the regulation blade with the developing roller shown in FIG. 3.

FIG. 5 is a graph showing a relationship between surface roughness of the regulation blade and time to failure of the developing roller.

FIG. 6 is a graph showing a relationship between polishing direction of the regulation blade and time to image failure.

FIG. 7 is a schematic sectional view showing an example of toner used in the developing device shown in FIG. 2.

### DETAILED DESCRIPTION

An embodiment of the present disclosure will be described below with reference to the drawings. The present disclosure, however, is not limited to what is specifically described below.

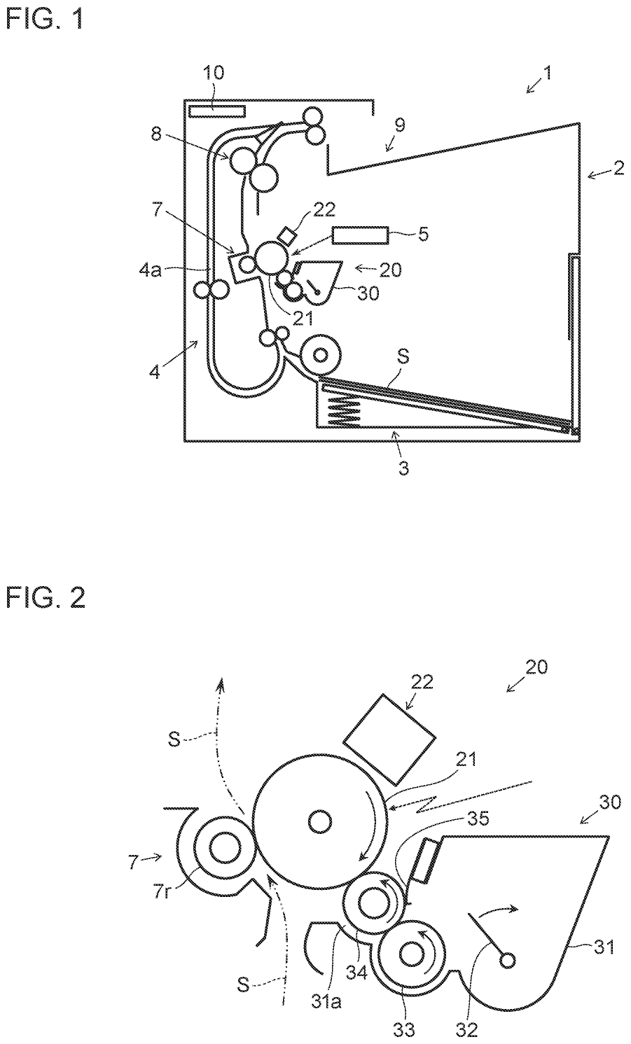

FIG. 1 is a schematic sectional side view of an image forming apparatus 1 according to an embodiment. FIG. 2 is a sectional side view of the vicinity of an image forming portion 20 of the image forming apparatus 1 shown in FIG. 1. One example of the image forming apparatus 1 of the present embodiment is what is called a printer that executes image formation and printing according to image data and printing instructions received from an external computer.

As shown in FIGS. 1 and 2, the image forming apparatus 1 includes, in a main body 2 thereof, a sheet feeding portion 3, a sheet conveying portion 4, an exposure portion 5, the image forming portion 20, a transfer portion 7, a fixing portion 8, a sheet discharge portion 9, and a control portion 10.

The sheet feeding portion 3 is disposed at a bottom part inside the main body 2 of the apparatus. The sheet feeding portion 3 stores therein a plurality of sheets S, and, during printing, feeds them out separately one by one to the sheet conveying portion 4.

The sheet conveying portion 4 is disposed on a downstream side of the sheet feeding portion 3 in a sheet conveyance direction. The sheet conveying portion 4 conveys a sheet S fed out from the sheet feeding portion 3 to the transfer portion 7 and then to the fixing portion 8, and further discharges the sheet S having undergone fixing into the sheet discharge portion 9. For double-sided printing, the sheet conveying portion 4 sorts the sheet S having a fixed image on a first side thereof into an inverting conveying portion 4a, and conveys the sheet S back to the transfer portion 7 and then to the fixing portion 8.

The exposure portion 5 is disposed in the vicinity of the image forming portion 20. The exposure portion 5 irradiates the image forming portion 20 with laser light that is controlled based on image data.

The image forming portion 20 is disposed above the sheet feeding portion 3, at a position that is on the downstream side of the sheet feeding portion 3 in the sheet conveyance direction. The image forming portion 20 includes a photosensitive drum (an image carrier) 21 that is supported to be rotatable in a predetermined direction (clockwise in FIGS. 1 and 2). The image forming portion 20 further includes a charging portion 22 and a developing device 30 that are arranged around the photosensitive drum 21 along a rotation direction thereof.

The photosensitive drum 21 is formed in a horizontally-extending cylindrical shape, and has a photosensitive layer on an outer circumferential surface thereof. The charging portion 22 uses corona discharge, for example, to charge the outer circumferential surface of the photosensitive drum 21 to a predetermined potential. The exposure portion 5 exposes, to light, the outer circumferential surface of the photosensitive drum 21 having been charged by the charging portion 22, and thereby forms an electrostatic latent image of a document image. The developing device 30 supplies toner to the electrostatic latent image to develop it, and thereby forms a toner image. In this manner, the image forming portion 20 forms an image on the sheet S.

Note that the image forming portion 20 is not provided with what is called a cleaning device known publicly that performs cleaning by removing untransferred toner left on the outer circumferential surface of the photosensitive drum 21 after a toner image is transferred onto the sheet S. The untransferred toner left on the outer circumferential surface of the photosensitive drum 21 is collected by the developing device 30.

The transfer portion 7 is adjacent to the photosensitive drum 21, and is disposed in the sheet conveying portion 4, at a position that is on an upstream side of the fixing portion 8 in the sheet conveying direction and that is below the fixing portion 8. The transfer portion 7 includes a transfer roller 7r. The transfer roller 7r contacts the outer circumferential surface of the photosensitive drum 21 to form a transfer nip portion. The transfer portion 7 transfers the toner image, which is formed on the outer circumferential surface of the photosensitive drum 21 at the image forming portion 20, onto the sheet S at the transfer nip portion.

The fixing portion 8 is disposed in the sheet conveying portion 4, at a position that is on a downstream side of the transfer portion 7 in the sheet conveying direction and that is above the transfer portion 7. The fixing portion 8 heats and presses the sheet S onto which the toner image has been transferred at the transfer portion 7 to thereby fix the toner image on the sheet S.

The sheet discharge portion 9 is disposed above the main body 2 of the apparatus, and is exposed outside the main body 2 of the apparatus. Onto the sheet discharge portion 9, the sheet S is discharged after the toner image is fixed at the fixing portion 8. The sheet S discharged on the sheet discharge portion 9 can be taken out from above the main body 2 of the apparatus.

The control portion 10 includes a CPU, a storage, an image processor, and other electronic circuits and parts (of which none is illustrated). The CPU controls operations of various components provided in the image forming apparatus 1 on the basis of a control program and control data stored in the storage, and thereby performs processing related to functions of the image forming apparatus 1. The sheet feeding portion 3, the sheet conveying portion 4, the exposure portion 5, the image forming portion 20, the transfer portion 7, and the fixing portion 8 each individually receive a command from the control portion 10, and cooperate with each other to perform printing with respect to a sheet S.

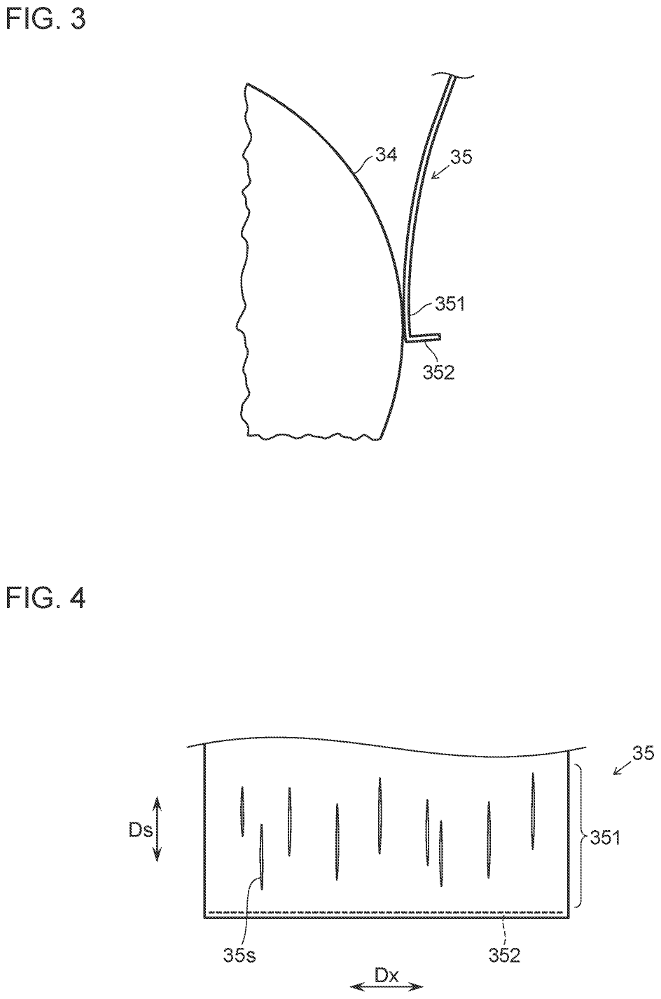

Next, a description will be given of a structure of the developing device 30, with reference to FIG. 3 as well as FIG. 2. FIG. 3 is a partial enlarged side view of the vicinity of a regulation blade 35 of the developing device 30 incorporated in the image forming portion 20 shown in FIG. 2. The developing device 30 supplies toner to the outer circumferential surface of the photosensitive drum 21. As shown in FIG. 2, the developing device 30 includes a development container 31, a stirring paddle 32, a supply roller 33, a developing roller (a toner carrier) 34, and the regulation blade 35.

The development container 31 has an elongated shape extending along an axial direction of the photosensitive drum 21 (a depth direction in the plane of the sheet of FIG. 2), and is disposed with a longitudinal direction thereof horizontal. The development container 31 has an opening 31a formed in part thereof opposite the photosensitive drum 21. The development container 31 contains a non-magnetic one-component toner as a developer. That is, the development container contains therein toner to be supplied to the photosensitive drum 21.

The stirring paddle 32 is disposed in a lower part inside the development container 31, at a position that is spaced away from the opening 31a via the developing roller 34 and the supply roller 33. The stirring paddle 32 is supported in the development container 31 so as to be rotatable about an axis thereof extending in parallel with the photosensitive drum 21. The stirring paddle 32 further includes a film portion that is flexible and extends in a radial direction thereof. The stirring paddle 32 rotates about the axis to thereby stir the toner inside the development container 31.

The supply roller 33 is disposed in the lower part inside the development container 31, at a position between the opening 31a and the stirring paddle 32. The supply roller 33 is disposed opposite the developing roller 34. The supply roller 33 is supported in the development container 31 so as to be rotatable about an axis extending in parallel with the photosensitive drum 21. The supply roller 33 carries thereon toner to be supplied to an outer circumferential surface of the developing roller 34 in a facing region between the supply roller 33 and the developing roller 34. The supply roller 33 rotates in the same direction as the developing roller 34.

The developing roller 34 is disposed in the opening 31a of the development container 31, and part thereof is exposed out of the development container 31. The developing roller 34 is disposed opposite the photosensitive drum 21. The developing roller 34 is supported in the developing container 31 to be rotatable about an axis extending parallel to the rotational axis of the photoconductive drum 21. The developing roller 34 carries thereon toner to be supplied to the outer circumferential surface of the photoconductive drum 21 in a facing region between the developing roller 34 and the photosensitive drum 21. The developing roller 34 rotates in a rotation direction opposite to the rotation direction of the photosensitive drum 21. The developing roller 34 supplies toner contained in the development container 31 to the outer circumferential surface of the photosensitive drum 21, and thereby develops an electrostatic latent image to form a toner image.

The regulation blade 35 is disposed on an upstream side of the facing region between the developing roller 34 and the photoconductive drum 21 in the rotation direction of the developing roller 34. The regulation blade 35 is fixed to the development container 31, and extends over a whole axial direction of the developing roller 34. Further, as shown in FIG. 3, the regulation blade 35 extends toward the developing roller 34 in a direction intersecting with the axial direction of the developing roller 34, and a leading-edge part of the regulation blade 35 contacts the outer circumferential surface of the developing roller 34. The regulation blade 35 has a contact portion 351 and a bent portion 352.

The contact portion 351 is disposed at the leading-edge part of the regulation blade 35 which extends toward the developing roller 34. The contact portion 351 contacts the outer circumferential surface of the developing roller 34. A predetermined contact pressure is applied to the regulation blade 35, and the contact portion 351 is pressed against the outer circumferential surface of the developing roller 34.

The bent portion 352 is adjacent to the contact portion 351. The bent portion 352 is bent along a bending line that extends along the axial direction of the developing roller 34. The bent portion 352 is bent in a direction away from the developing roller 34. In other words, the bent portion 352 extends outward in a radial direction of the developing roller 34. Thereby, part of the toner carried on the outer circumferential surface of the developing roller 34 is sent outward in the radial direction of the developing roller 34.

Further, the bent portion 352 is formed by bending a metal material constituting the regulation blade 35 in a direction same as a rolling direction of the metal material. With this structure, it is easy to bend the regulation blade 35, and thus the bent portion 352 can be formed easily.

The toner contained in the development container 31 is stirred and circulated by the stirring paddle 32 to be carried on an outer circumferential surface of the supply roller 33. The toner carried on the outer circumferential surface of the supply roller 33, along with rotation of the supply roller 33, is caused to be carried on the outer circumferential surface of the developing roller 34. The toner carried on the outer circumferential surface of the developing roller 34 has a thickness of a layer thereof regulated by the regulation blade 35, and is charged as a result of friction with the regulation blade 35.

The toner carried on the outer circumferential surface of the developing roller 34, along with rotation of the developing roller 34, is conveyed to the facing region between the developing roller 34 and the photosensitive drum 21. When a predetermined developing voltage is applied to the developing roller 34, due to a potential difference between the developing roller 34 and the surface of the photosensitive drum 21, the toner carried on the outer circumferential surface of the developing roller 34 is caused to be supplied to the outer circumferential surface of the photosensitive drum 21 in the facing region. In this manner, an electrostatic latent image on the outer circumferential surface of the photosensitive drum 21 is developed with the toner.

Next, a description will be given of a more detailed structure of the regulation blade 35, with reference to FIG. 4. FIG. 4 is a schematic explanatory view of a contact region of the regulation blade 35 with the developing roller 34 shown in FIG. 3. FIG. 4 is a diagram showing the contact portion 351 of the regulation blade 35 as seen in a direction of opposing the contact region (the contact portion 351) of the regulation blade 35 and the developing roller 34 in FIG. 3, that is, as seen in a direction outward in the radial direction from the left side in FIG. 3, which is the side of the developing roller 34 in FIG. 3. “Dx” denotes the axial direction of the developing roller 34. Note that, although polishing scratches 35s are illustrated in the contact portion 351 in FIG. 4 for convenience of description, actually observed polishing scratches are much smaller than the polishing scratches 35s illustrated in FIG. 4.

A toner moving direction Ds in the contact region (the contact portion 351) between the regulation blade 35 and the developing roller 34 is a direction same as a moving direction of the outer circumferential surface of the developing roller 34 which is opposite the contact portion 351. The regulation blade 35 is formed of a metal material polished in a direction same as the toner moving direction Ds in the contact region (the contact portion 351) between the regulation blade 35 and the developing roller 34. Thereby, the polishing scratches 35s formed on a surface of the contact portion 351 opposite the outer circumferential surface of the developing roller 34 extend in a direction same as the toner moving direction Ds.

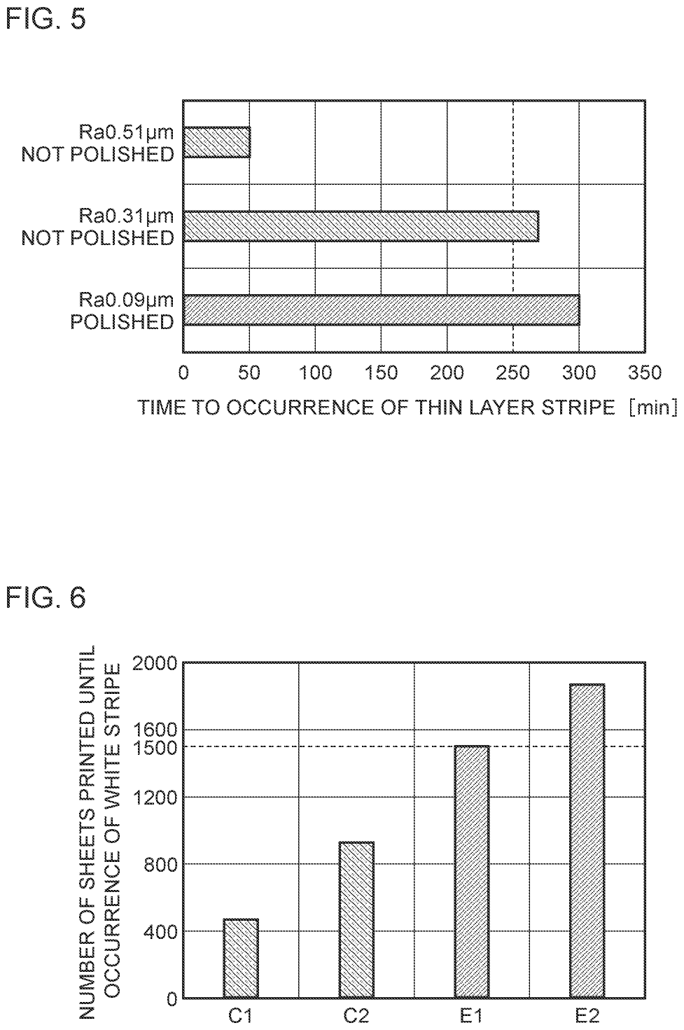

Next, a description will be given of surface roughness of the regulation blade 35, with reference to FIG. 5. FIG. 5 is a graph showing a relationship between surface roughness of the regulation blade 35 and time to failure of the developing roller 34. In FIG. 5, the horizontal axis indicates amount of time until occurrence of a thin layer stripe on the outer circumferential surface of the developing roller 34. In FIG. 5, the vertical axis indicates three samples different from each other in surface roughness of the regulation blade 35 (arithmetic average roughness Ra: 0.51 μm, 0.31 μm, 0.09 μm). Note that, in a case where no polishing is done, the absolute value of the arithmetic average roughness Ra increases, and also the variation thereof increases, and thus the sample with the smallest arithmetic average roughness Ra of 0.09 μm was polished.

Here, by using the three samples different from each other in surface roughness of the regulation blade 35, the developing roller 34 was rotated at a same linear speed (peripheral speed) as in a normal operation of the developing device 30, and evaluation was made of amounts of time until occurrence of a thin layer stripe, which is failure caused on the outer circumferential surface of the developing roller by toner stuck to the regulation blade 35. Note that, for preferable operation of the developing device 30, it is preferable that the amount of time until occurrence of a thin layer stripe on the outer circumferential surface of the developing roller 34 be 250 minutes or more, and this value was set as a technical goal.

According to FIG. 5, with the regulation blade 35 having the arithmetic average roughness Ra of 0.51 μm, the amount of time until occurrence of a thin layer stripe on the outer circumferential surface of the developing roller 34 was 50 minutes. In contrast, with the regulation blade 35 having the arithmetic average roughness Ra of 0.31 μm or 0.09 μm, the amount of time until occurrence of a thin layer stripe on the outer circumferential surface of the developing roller 34 was over 250 minutes. Accordingly, it is preferable that the arithmetic average roughness of the surface of the regulation blade 35 be 0.3 μm or less.

Next, a description will be given of a polishing direction of the surface of the regulation blade 35, with reference to FIG. 6. FIG. 6 is a graph showing a relationship between polishing direction of the regulation blade 35 and time to image failure. In FIG. 6, the horizontal axis indicates four samples (C1, C2, E1, E2) different from each other in polishing direction of the surface of the regulation blade 35. “C1” is a regulation blade of a first comparative example, and the regulation blade was not polished. “C2” is a regulation blade of a second comparative example, and the regulation blade was polished in a direction orthogonal to the toner moving direction Ds (see FIG. 4) in the contact region between the regulation blade and the developing roller. “E1” is a regulation blade 35 of a first example of the present disclosure, and the surface of the regulation blade 35 was polished in a direction same as the toner moving direction Ds on the surface of the regulation blade 35. As to “E2”, which is a regulation blade 35 of a second example of the present disclosure, and the regulation blade 35 was polished in a direction same as the toner moving direction Ds on the surface of the regulation blade 35, a detailed description will be given later. In FIG. 6, the vertical axis indicates amount of time (number of sheets printed) until occurrence of a white stripe (a break in an image) on a sheet as a recording medium.

Here, using the four samples different from each other in polishing direction of the surface of the regulation blade 35, a durability experiment was conducted in an environment with a temperature of 23° C. and a humidity of 50%. In this experiment, an operation of printing a document with a coverage rate of 3.8% on two sheets was repeated at intervals of 400 seconds, and evaluation was made of amount of time (number of sheets printed) until occurrence of a thin layer stripe, which is failure caused by toner stuck to the regulation blade 35. Note that, for preferable operation of the developing device 30, it is preferable that the number of sheets printed (the amount of time) until occurrence of a thin layer stripe on a sheet be 1500 or more, and this value was set as a technical goal.

An example of experiment conditions is shown in Table 1. Note that the value of resistance of the developing roller 34 indicated in Table 1 was calculated from the value of a current that flowed through the developing roller 34 when the outer circumferential surface of the developing roller 34 was brought into contact with a metal roller one end of which was grounded and a voltage of +100 V was applied to the developing roller 34 while rotating the developing roller 34.

TABLE 1

| Member | Item | Data |
|---|---|---|
| Developing | Material | Silicone Rubber + |
| Roller | | Urethane Coating |
| | Rubber Layer Thickness (mm) | 3.5 |
| | Outer Diameter (mm) | Φ13 |
| | Shaft diameter (mm) | Φ6 |
| | Rubber Length (mm) | 232 |
| | Linear Speed (mm/s) | 195 |
| | ASKER-C Hardness (°) | 70 |
| | Resistance (logΩ) | 7.1 |
| Regulation | Material | SUS304 |
| Blade | Free Length (mm) | 10 |
| | Contact Pressure (N/m) | 40 |
| Toner | Material | Polyester Resin |
| | Production Method | Pulverization Method |
| | Median Particle Diameter | 8.0 |
| | Circularity | 0.96 |
| Photosensitive | Material | Positively Charged |
| Drum | | Single Layer OPC |
| | Outer Diameter (mm) | Φ24 |
| | Photosensitive-Layer | 22 |
| | Thickness (μm) | |

According to FIG. 6, with the regulation blade of the first comparative example C1, which was not polished, the number of sheets printed until occurrence of a white stripe was 470. Further, with the regulation blade of the second comparative example C2, which was polished in the direction orthogonal to the toner moving direction Ds in the contact region between the regulation blade and the developing roller, the number of sheets printed until occurrence of a white stripe was 930. In contrast to these, with the regulation blade 35 of the first example E1, which was polished in a direction same as the toner moving direction Ds in the contact region between the regulation blade 35 and the developing roller 34, the number of sheets printed until occurrence of a white stripe was 1500. Accordingly, it is preferable that the regulation blade 35 be formed of a metal material that is polished in a direction same as the toner moving direction Ds in the contact region (the contact portion 351) between the regulation blade 35 and the developing roller 34.

That is, based on FIGS. 5 and 6, the regulation blade 35 is formed of a metal material polished in a direction same as the toner moving direction Ds in the contact region between the regulation blade 35 and the developing roller 34 such that the arithmetic average roughness of the surface of the regulation blade 35 is 0.3 μm or less. With this structure, movement of toner is not obstructed on the outer circumferential surface of the developing roller 34. This helps the toner to move smoothly on the outer circumferential surface of the developing roller 34, and thus helps to suppress sticking of toner to the regulation blade 35. Accordingly, with the developing device 30 of the present disclosure, it is possible to obtain high-quality images over a long-term use.

In relation to Table 1, there are some more preferable experiment conditions as below.

The developing roller 34 had a surface free energy of 5 mJ/m² or more but 27 mJ/m² or less. The regulation blade 35 had a contact area ratio of 4.5 to 10.0%, more preferably 6.8 to 8.0%, with respect to the developing roller 34, and the contact pressure applied to the regulation blade 35 was 10 to 60 N/m, more preferably 35 to 45 N/m. For the surface roughness of the developing roller 34, coating containing particles may be applied to the developing roller 34, or the surface roughness may be obtained only by polishing. There is no particular limitation to the method for producing the developing roller 34.

The toner is pulverized toner manufactured by a pulverization method. Polymerized toner, which is high in circularity, has a same tendency as pulverized toner, but, having a spherical shape, polymerized toner is unlikely to stick to the regulation blade 35. The present technology is basically adapted to pulverized toner, which is more likely to stick to the regulation blade 35 but is lower in cost than polymerized toner.

The circularity of the toner was 0.96 according to Table 1, but it has been confirmed that similar results can be obtained when the circularity is in a range of 0.93 to 0.97. A circularity of 0.93 or less tends to cause degradation in image quality, and thus is not preferable. A circularity of 0.97 or more pushes up the production cost considerably, and thus is not preferable.

As to difference in linear speed between the photosensitive drum 21 and the developing roller 34, it has been confirmed that similar results can be obtained when the difference is in a range of 1.1 to 1.6 times (the developing roller 34 rotates faster than the photosensitive drum 21). A difference in linear speed of less than 1.1 times causes fog where toner unintendedly adheres to a white background part of a sheet, and thus is not preferable. A difference in linear speed of 1.6 times or more increases device driving torque, vibration, and toner stress, and thus is not preferable in terms of device life.

As to biases, it has been confirmed that similar results can be obtained when the photosensitive-member surface potential is in a range of 500 to 800 V and the photosensitive-member post-exposure potential is in a range of 70 to 200 V.

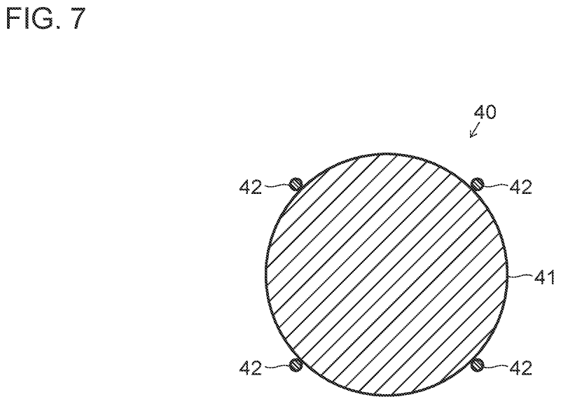

Next, a description will be given of toner 40 used in the developing device 30, with reference to FIG. 7. FIG. 7 is a schematic sectional view showing an example of the toner 40 used in the developing device 30 shown in FIG. 2. Particles of the toner 40 each include a toner mother particle 41 and fluororesin particles 42. The fluororesin particles 42 are an external additive adhered to a surface of the toner mother particle 41. The fluororesin particles 42 tend to be unlikely to adhere to other substances.

Here, in a case where an area ratio of a region in the surface of the toner mother particle 41 that is covered with the fluororesin particles 42 is 0.9% or less, it is impossible to obtain a sufficient effect of suppressing sticking of the toner to the regulation blade 35. On the other hand, an increased area ratio of the region in the surface of the toner mother particle 41 that is covered with the fluororesin particles 42 tends to increase an amount of toner conveyed on the outer circumferential surface of the developing roller 34. This then increases the possibility of occurrence of a fog on a white background part of a sheet, and thus, it is preferable that an upper limit of the area ratio be 2.0%.

Further, a number average primary particle diameter of the fluororesin particles 42 affects adhesion of the fluororesin particles 42 with respect to the surface of the toner mother particle 41. The adhesion of the fluororesin particles 42 with respect to the surface of the toner mother particle 41 is higher as the number average primary particle diameter of the fluororesin particles 42 is smaller, and is lower as the number average primary particle diameter of the fluororesin particles 42 is larger. Thus, if the number average primary particle diameter of the fluororesin particles 42 is 120 nm or more but 280 nm or less, it is easy to control the area ratio of the region in the surface of the toner mother particle 41 that is covered with the fluororesin particles 42.

Next, regarding the toner 40, a description will be given of a relationship between polishing direction of the regulation blade 35 and time to image failure shown in FIG. 6. “E2” in FIG. 6 is the second example of the present disclosure, in which the surface of the regulation blade 35 was polished in a direction same as the toner moving direction Ds on the regulation blade 35, and further the toner 40 used therein included the fluororesin particles 42. According to FIG. 6, with the regulation blade 35 of the second example E2, the number of sheets printed until occurrence of a white stripe was 1870. It was found out that, as compared with the regulation blade 35 of the first example E1, in which the toner did not include fluororesin particles, the time (the number of sheets printed) until occurrence of image failure further increased with the regulation blade 35 of the second example E2.

Based on the above description, in the toner 40 used in the developing device 30, it is preferable that the number average primary particle diameter of the fluororesin particles 42 be 120 nm or more but 280 nm or less. And, it is preferable that the area ratio of the region in the surface of the toner mother particle 41 that is covered with the fluororesin particles 42 be 0.9% or more but 2.0% or less. With this structure, it is possible to improve toner fluidity, and thus to improve toner circulating performance in the contact region between the regulation blade 35 and the developing roller 34. As a result, it is possible to suppress sticking of toner to the regulation blade 35.

The above-described embodiment is by no means meant to limit the scope of the present disclosure, and various modifications can be made and implemented within the scope not departing from the gist of the present disclosure.

For example, in the above embodiment, the image forming apparatus 1 is described as an image forming apparatus for monochrome printing, which records a monochrome image on a sheet S, but the image forming apparatus 1 is not limited to an image forming apparatus of such type. The image forming apparatus 1 may be an image forming apparatus for color printing, for example.

What is claimed is:

1. A developing device, comprising:
a development container that contains therein toner to be supplied to an image carrier;
a toner carrier that is rotatably supported in the development container and that supplies the toner contained in the development container to the image carrier in a facing region between the toner carrier the image carrier; and
a regulation blade that contacts the toner carrier on an upstream side of the facing region in a rotation direction of the toner carrier and that regulates a thickness of a layer of the toner carried on the toner carrier,
wherein
the regulation blade is formed of a metal material polished in a direction same as a toner moving direction in a contact region between the regulation blade and the toner carrier such that an arithmetic average roughness of a surface of the regulation blade is 0.3 μm or less.

2. The developing device according to claim 1,
wherein
particles of the toner each include a toner mother particle and fluororesin particles, which are an external additive adhered to a surface of the toner mother particle;
a number average primary particle diameter of the fluororesin particles is 120 nm or more but 280 nm or less; and
an area ratio of a region in a surface of the toner mother particle that is covered with the fluororesin particles is 0.9% or more but 2.0% or less.

3. The developing device according to claim 1,
wherein
the regulation blade has
a contact portion that contacts an outer circumferential surface of the toner carrier, and
a bent portion that is adjacent to the contact portion and that is bent in a direction away from the toner carrier; and
the bent portion is formed by bending the metal material in a direction same as a rolling direction of the metal material.

4. An image forming apparatus comprising the developing device according to claim 1.
